(19) United States
(12) Patent Application Publication
(10) Pub. No.: US 2007/0280642 A1
(43) Pub. Date: Dec. 6, 2007

(54) Content reception apparatus and content reception method

(76) Inventor: Takuya Nishimura, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/803,000

(22) Filed: May 29, 2007

(30) Foreign Application Priority Data
May 30, 2006 (JP) 2006-150213

(51) Int. Cl. H04N 7/00

(52) U.S. Cl. 386/95

(57) ABSTRACT

There is provided a content reception apparatus that, when receiving content and recording the content onto a write-once medium, is capable of preventing the single piece of content from being divided into two parts, each recorded in a separate apparatus, and also preventing any part of the content from being lost, even when a network trouble occurs during reception of the content. The content reception apparatus includes: a primary storage medium which is a storage medium that allows multiple rewriting; a secondary storage medium which is a write-once storage medium; a reception unit which receives the content; a recording unit which records the content received by the reception unit onto the primary storage medium; a first check unit which checks, in conjunction with a content transmission apparatus, that the reception unit has completed reception of a whole of the content to be received; and a moving unit which, when the whole of the content to be received has been recorded on the primary storage medium, moves the content recorded on the primary storage medium to the secondary storage medium. When a content which cannot be duplicated and which is recorded on a storage medium in the content transmission apparatus is to be moved to the secondary storage medium, the moving unit moves the content recorded on the primary storage medium to the secondary storage medium after the check by the first check unit is completed.

### BACKGROUND OF THE INVENTION

(1) Field of the Invention

The present invention relates to a technology for moving content via a network or a bus.

(2) Description of the Related Art

As a conventional technology for moving content via a network or a bus, there is “Move” defined in a Digital Transmission Content Protection (DTCP) standard (see, for example, Japanese Unexamined Patent Application Publication No. 2005-244576). While copyright-protected content of which recording is possible only once is prohibited from being copied from one device to another, “moving” thereof (i.e., recording the content in a device at the receiving end and, at the same time, deleting the content in a device at the transmitting end) is permitted. This operation of recording the content in the device at the receiving end and, at the same time, deleting the content in the device at the transmitting end is referred to as “moving”.

FIGS. 1 and 2 illustrate a conventional content moving technique described in the aforementioned Japanese Unexamined Patent Application Publication No. 2005-244576. As illustrated in FIG. 1, a hard disk recorder 101 and a DVD recorder 102 are connected to each other via a network 100. In accordance with an instruction (not shown) from a user, a controller 108 within the hard disk recorder 101 moves copy-once content (not shown) recorded on an HDD 103 within the hard disk recorder 101 to a DVD-R 104, which is a write-once medium (i.e., a medium on which writing is possible only once), within the DVD recorder 102. Specifically, the controller 108 first transmits a content recording start command 130 to the DVD recorder 102 on the network 100 via a network interface 107 (step S101 in FIG. 2). Next, the controller 108 reads the copy-once content on the HDD 103 via a file reading unit 201, and starts transmitting the read content to the DVD recorder 102 via the network interface 107 (step S102 in FIG. 2). Upon receipt of the recording start command 130 via a network interface 106, a controller 109 within the DVD recorder 102 issues a DVD-writing instruction 220 to a recording circuit 105. Upon receipt of the DVD-writing instruction 220, the recording circuit 105 records the copy-once content transmitted from the hard disk recorder 101 onto the DVD-R 104 (step S103 in FIG. 2). The hard disk recorder 101 deletes the copy-once content, transmission of which has been completed, from the HDD 103 (step S104 in FIG. 2). Thus, the moving of the content from the HDD 103 to the DVD-R 104 is completed.

### SUMMARY OF THE INVENTION

When a network trouble occurs while the copy-once content is being transferred, it may so happen that communication between the hard disk recorder 101 and the DVD recorder 102 is broken, resulting in difficulty in continuing the transfer of the content. When this happens, the above-described conventional technique may cause a problem in that the single piece of content is divided into two parts, with one recorded in one device and the other recorded in the other device, or that a part of the content is lost.

For example, suppose that transmission (sending) of the content by the hard disk recorder 101 is performed on a minute-by-minute basis. In this case, each time the hard disk recorder 101 transmits a one-minute portion of the copy-once content, the hard disk recorder 101 deletes from the HDD 103 the portion of the copy-once content of which the transmission has been completed. In the case where the content is thirty minutes long, this cycle is repeated thirty times to complete the moving of the content. Suppose here that a network trouble occurs when this cycle has been repeated fifteen times, making impossible the communication between the hard disk recorder 101 and the DVD recorder 102. In this case, because of an inability to continue the communication with the DVD recorder 102, the hard disk recorder 101 stops the transmission and deletion of the content on one hand, and on the other, the DVD recorder 102 stops the recording of the content. As a result, referring to FIG. 3A, the single piece of content a1 to a30 having an original length of thirty minutes is divided into two parts, with one part composed of portions a1 to a15 corresponding to the first fifteen minutes recorded on the DVD-R 104 and the other part composed of portions a16 to a30 corresponding to the second fifteen minutes remaining on the HDD 103. As described above, the above-described conventional technique involves the problem in that the single piece of content may be divided into two parts, with one recorded in one device and the other recorded in the other device.

Moreover, the hard disk recorder 101 does not have a means for checking whether a one-minute portion of the content being transferred at the time when the network trouble has occurred has been successfully received by and recorded on the DVD recorder 102. Because a copy of the content should not exist at a plurality of locations in order to observe a regulation of “Move”, the hard disk recorder 101 deletes this one-minute portion of the content from the HDD 103 for the sake of safety. In this case, when this one-minute portion of the content has been recorded on the DVD-R 104 successfully, loss of the content does not occur. However, when this one-minute portion of the content has not been received by the DVD recorder 102 successfully, this one-minute portion a15 of the content is not recorded on the DVD-R 104 (see FIG. 3B). That is, the above-described conventional technique has a problem in that a part or the whole of a one-minute portion (in the above example, the portion a15) of the thirty-minute content a1 to a30 may be lost.

The present invention is conceived to solve the above-described problems, and an object of the present invention is to provide a content reception apparatus that, when receiving content from another apparatus and recording the content onto a write-once medium, is capable of preventing the single piece of content from being divided into two parts, each recorded in a separate one of the two apparatuses, and also preventing any part of the content from being lost, even when the network trouble occurs during reception of the content.

In order to achieve the aforementioned object, the content reception apparatus according to the present invention is a content reception apparatus that receives a content, the content reception apparatus including: a primary storage medium which is a storage medium that allows multiple rewriting; a secondary storage medium which is a write-once storage medium; a reception unit which receives the content; a recording unit which records the content received by the reception unit onto the primary storage medium; a first check unit which checks, in conjunction with a content transmission apparatus, that the reception unit has completed reception of a whole of the content to be received; and a moving unit which moves the content recorded on the primary storage medium to the secondary storage medium, when the whole of the content to be received has been recorded on the primary storage medium, wherein, when a content which cannot be duplicated and which is recorded on a storage medium in the content transmission apparatus is to be moved to the secondary storage medium, the moving unit moves the content recorded on the primary storage medium to the secondary storage medium after the check by the first check unit is completed. Thus, the content reception apparatus is able to move the content recorded on the primary storage medium to the secondary storage medium after the check by the first check unit is completed. Therefore, it is possible to prevent the single piece of content from being divided into two parts, each recorded in a separate apparatus. In addition, it is possible to prevent any part of the content from being lost.

Here, it is also possible that the content reception apparatus further includes a deletion unit which deletes or makes unusable the content recorded on the primary storage medium, when the whole of the content to be received has not been recorded on the primary storage medium successfully. Thus, when the whole of the content to be received has not been recorded on the primary storage medium successfully, the content recorded on the primary storage medium is deleted or made unusable. This makes it possible to prevent copyright-protected content from existing at multiple apparatuses.

Furthermore, it is also possible that the content reception apparatus further includes a second check unit which checks, in conjunction with the content transmission apparatus and by using a command, a failure in completion of transfer of a predetermined unit amount, wherein the deletion unit deletes or makes unusable the content recorded on the primary storage medium, when the failure in the completion of the transfer of the predetermined unit amount is verified by the second check unit. This enables the content reception apparatus to check, in conjunction with the content transmission apparatus, the failure in completion of the transfer of a predetermined unit amount by a simple method using the command.

Furthermore, it is also possible that the first check unit determines that transfer of a predetermined unit amount has been completed successfully, when a length of the content recorded on the primary storage medium has reached a length of the content to be received. This makes it possible to move the content recorded on the primary storage medium to the secondary storage medium when the length of the content recorded on the primary storage medium has reached the length of the content to be received.

Furthermore, it is also possible that the second check unit determines that the transfer of the predetermined unit amount has not been completed successfully, when neither the content nor the command has been received from the content transmission apparatus for a predetermined time. This makes it possible to delete or make unusable the content recorded on the primary storage medium when neither the content nor the command has been received from the content transmission apparatus for a predetermined time.

Furthermore, it is also possible that the first check unit checks completion of transfer on a file-by-file basis or on a program-by-program basis, and the moving unit moves the content recorded on the primary storage medium to the secondary storage medium on a file-by-file basis or on a program-by-program basis. This makes it possible to move the content recorded on the primary storage medium to the secondary storage medium on an appropriate basis such as on a file-by-file basis or on a program-by-program basis.

Furthermore, it is also possible that the second check unit checks the failure in the completion of the transfer, on a file-by-file basis or on a program-by-program basis, and the deletion unit deletes or makes unusable the content recorded on the primary storage medium, on a file-by-file basis or on a program-by-program basis. This makes it possible to delete or make unusable the content recorded on the primary storage medium on an appropriate basis such as on a file-by-file basis or on a program-by-program basis.

Furthermore, it is also possible that the content reception apparatus further includes: a decryption unit which, when the content received is encrypted, decrypts the encrypted content; and an encryption unit which encrypts again the content decrypted by the decryption unit, wherein the moving unit moves the content encrypted again by the encryption unit to the secondary storage medium. Thus, in the case where the content received is encrypted, it is possible to encrypt the content again, using a different encryption system.

Furthermore, it is also possible that the decryption unit decrypts a content which is encrypted using an encryption system specified in the Digital Transmission Content Protection (DTCP) standard. This enables the content reception apparatus to function as an apparatus for receiving content encrypted using an encryption system specified in a DTCP standard.

Furthermore, it is also possible that the content reception apparatus further includes a selection unit which selects either the primary storage medium or the secondary storage medium as a recording destination of the received content, wherein the moving unit moves the content recorded on the primary storage medium to the secondary storage medium, only when the secondary storage medium is selected by the selection unit. This makes it possible to achieve the same effects as those described above not only when the content is to be recorded onto the secondary storage medium which is a write-once storage medium but also when the content is to be recorded onto the primary storage medium which is a storage medium that allows multiple rewriting.

Note that the present invention can be implemented not only as such content reception apparatus but also as a content transmission apparatus that has units corresponding to the characteristic units of the above content reception apparatus, a content reception method having steps corresponding to the characteristic units of the above content reception apparatus, and a program that causes a computer to execute these steps. Needless to say, such a program can be delivered via a storage medium, such as a CD-ROM, or a transmission medium, such as the Internet.

As is apparent from the above description, the content reception apparatus according to the present invention makes it possible to move, after the whole of the content to be received is recorded onto the primary storage medium which is a storage medium that allows multiple rewriting, the content recorded on the primary storage medium to the secondary storage medium which is a write-once storage medium. This makes it possible to prevent the single piece of content from being divided into two parts, each recorded in a separate apparatus, and to provide any part of the content from being lost.

### FURTHER INFORMATION ABOUT TECHNICAL BACKGROUND TO THIS APPLICATION

The disclosure of Japanese Patent Application No. 2006-150213 filed on May 30, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram of a conventional content moving system;

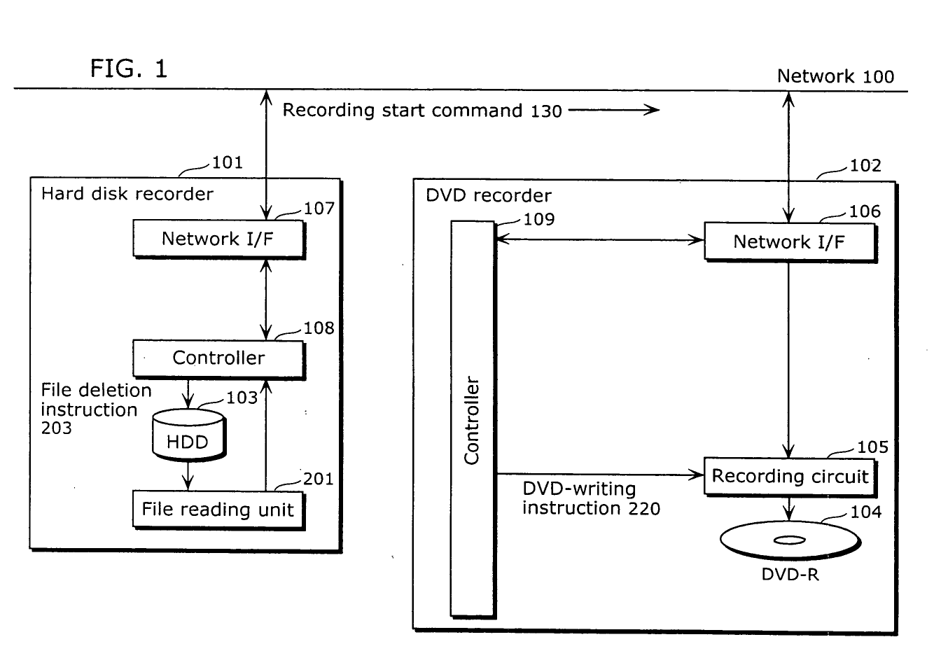

FIG. 2 is a diagram illustrating a conventional content moving procedure;

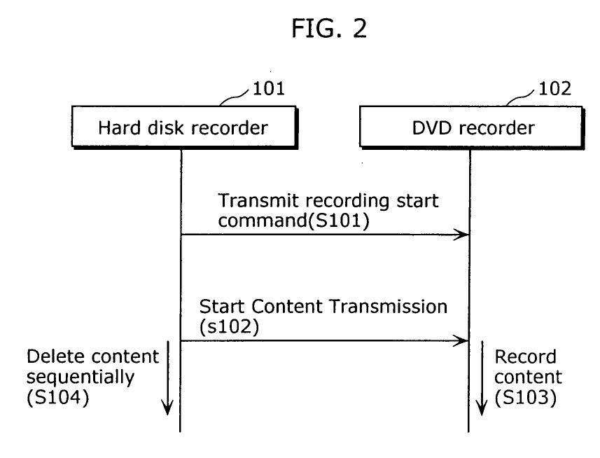

FIGS. 3A and 3B illustrate problems of a conventional technique;

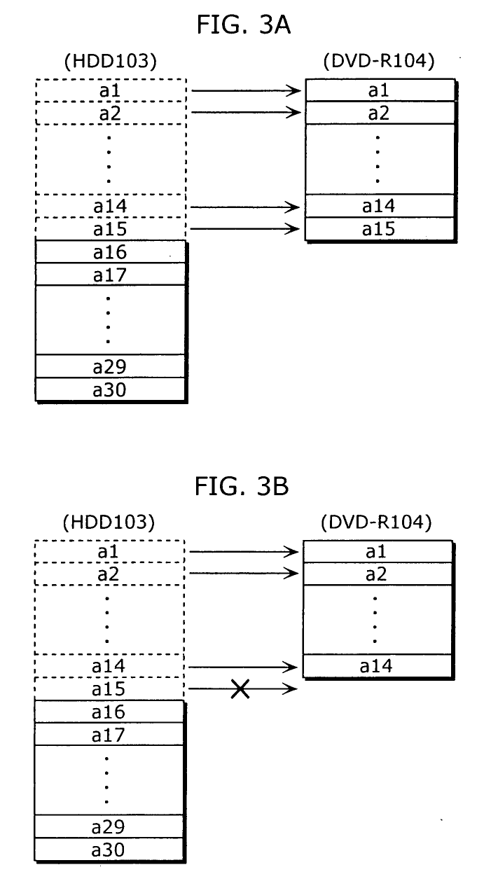

FIG. 4 is an external view of a content moving system according to one embodiment of the present invention;

FIG. 5 is a block diagram of the content moving system according to this embodiment of the present invention;

FIG. 6 is a flowchart illustrating a content moving procedure according to this embodiment of the present invention;

FIG. 7 illustrates a program list according to one embodiment of the present invention;

FIG. 8 is a block diagram of another content moving system according to one embodiment of the present invention; and

FIG. 9 illustrates a content recording destination list according to one embodiment of the present invention.

### DESCRIPTION OF THE PREFERRED EMBODIMENTS

Hereinafter, embodiments of the present invention will be described with reference to the accompanying drawings.

### Embodiments

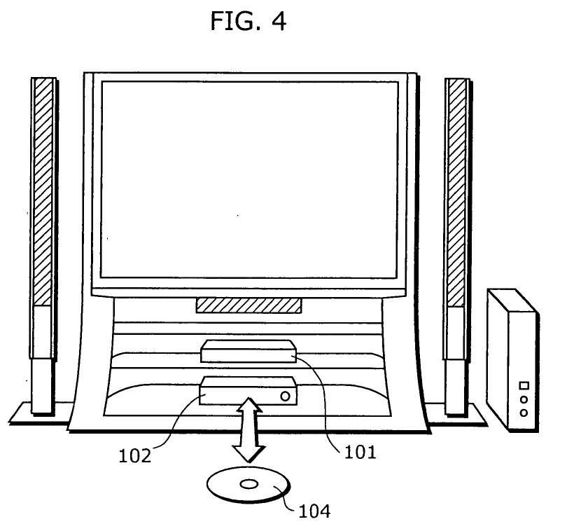

FIG. 4 is an external view of a content moving system according to one embodiment of the present invention. This content moving system includes a hard disk recorder 101 and a DVD recorder 102. The hard disk recorder 101 and the DVD recorder 102 are connected to each other via a network, which is not shown in the figure.

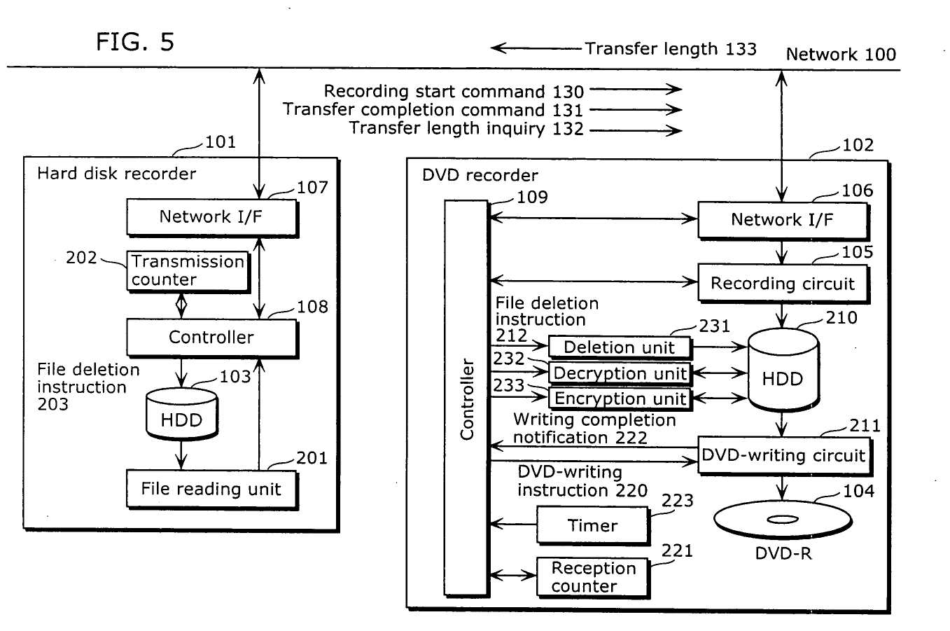

FIG. 5 illustrates the content moving system according to this embodiment of the present invention. As described above, the hard disk recorder 101 and the DVD recorder 102 are connected to each other via a network 100. Both the hard disk recorder 101 and the DVD recorder 102 conform to a DTCP standard.

The hard disk recorder 101 is a content transmission apparatus that transmits content. The hard disk recorder 101 includes a network I/F 107, a transmission counter 202, a controller 108, an HDD 103, and a file reading unit 201. It is assumed that copy-once content (i.e., a content which cannot be duplicated) has been recorded on the HDD 103 beforehand. The controller 108 issues a read instruction specifying a file name of the content to the file reading unit 201, thereby reading information of a length of a specified file and the content itself from the HDD 103 via the file reading unit 201. In addition, the controller 108 issues a file deletion instruction 203 specifying a file name to the HDD 103, thereby deleting a specific piece of content on the HDD 103. The network I/F 107 is a processing unit for transmitting the content to the DVD recorder 102 via the network 100. The network I/F 107 is an exemplary transmission unit according to the present invention. The transmission counter 202 is a counter for counting a length of content that has been transmitted to the DVD recorder 102 via the network interface 107. A first check unit according to the present invention is realized by the transmission counter 202 and the controller 108.

The DVD recorder 102 is a content reception apparatus that receives the content. The DVD recorder 102 includes a controller 109, a network I/F 106, a recording circuit 105, an HDD 210, a DVD-writing circuit 211, a DVD-R 104, a timer 223, a reception counter 221, a deletion unit 231, a decryption unit 232, and an encryption unit 233.

The HDD 210 is a storage medium which allows multiple rewriting. The HDD 210 is an exemplary primary storage medium according to the present invention. The DVD-R 104 is a write-once storage medium. The DVD-R 104 is an exemplary secondary storage medium according to the present invention. The network I/F 106 is a processing unit for receiving the content from the hard disk recorder 101 via the network 100. The network I/F 106 is an exemplary reception unit according to the present invention.

The controller 109 is a processing unit for controlling each part of the DVD recorder 102. For example, the controller 109 issues a file deletion instruction 212 to the HDD 210, thereby deleting content on the HDD 210. In addition, the controller 109 issues a DVD-writing instruction 220 to the DVD-writing circuit 211, thereby writing the content on the HDD 210 to the DVD-R 104.

The recording circuit 105 is a processing unit for recording the content received via the network I/F 106 onto the HDD 210. The recording circuit 105 is an exemplary recording unit according to the present invention. Upon receipt of the DVD-writing instruction 220 from the controller 109, the DVD-writing circuit 211 writes the content recorded on the HDD 210 to the DVD-R 104. The deletion unit 231 is a processing unit for, upon receipt of the file deletion instruction 212 from the controller 109, deleting the content recorded on the HDD 210 or making the content recorded on the HDD 210 unusable. The deletion unit 231 is an exemplary deletion unit according to the present invention.

The reception counter 221 is a counter for counting a length of the content recorded by the recording circuit 105 onto the HDD 210. The reception counter 221 is used when checking completion of transfer of a predetermined unit amount (e.g., the whole of the content) in conjunction with the hard disk recorder 101. A value of the reception counter 221 is read and written by the controller 109. A first check unit according to the present invention is realized by the reception counter 221 and the controller 109.

The timer 223 is used when checking a failure in the completion of the transfer of the predetermined unit amount in conjunction with the hard disk recorder 101. A value measured by the timer 223 is inputted to the controller 109. A second check unit according to the present invention is realized by the timer 223 and the controller 109.

The decryption unit 232 is a processing unit for, in the case where the content received is encrypted, decrypting the encrypted content. The decryption unit 232 is an exemplary decryption unit according to the present invention. The encryption unit 233 is a processing unit for encrypting again the content decrypted by the decryption unit 232. The encryption unit 233 is an exemplary encryption unit according to the present invention.

Hereinafter, the DVD-writing circuit 211 and the deletion unit 231 will be sometimes referred to collectively as a “moving unit”. That is, a moving unit according to the present invention is a processing unit that combines a function of the DVD-writing circuit 211 and a function of the deletion unit 231. When the whole of the content that is to be received has been recorded on the HDD 210, the moving unit moves the content recorded on the HDD 210 to the DVD-R 104.

The structure of a content reception apparatus according to the present invention is not limited to a structure as illustrated in FIG. 5. For example, although the deletion unit 231 and the HDD 210 are shown in FIG. 5 as being separate processing units, the deletion unit 231 may be considered as being contained in the HDD 210. Similarly, although the decryption unit 232 and the encryption unit 233 are shown in FIG. 5 as being processing units separate from the controller 109, the decryption unit 232 and the encryption unit 233 may be considered as being contained in the controller 109.

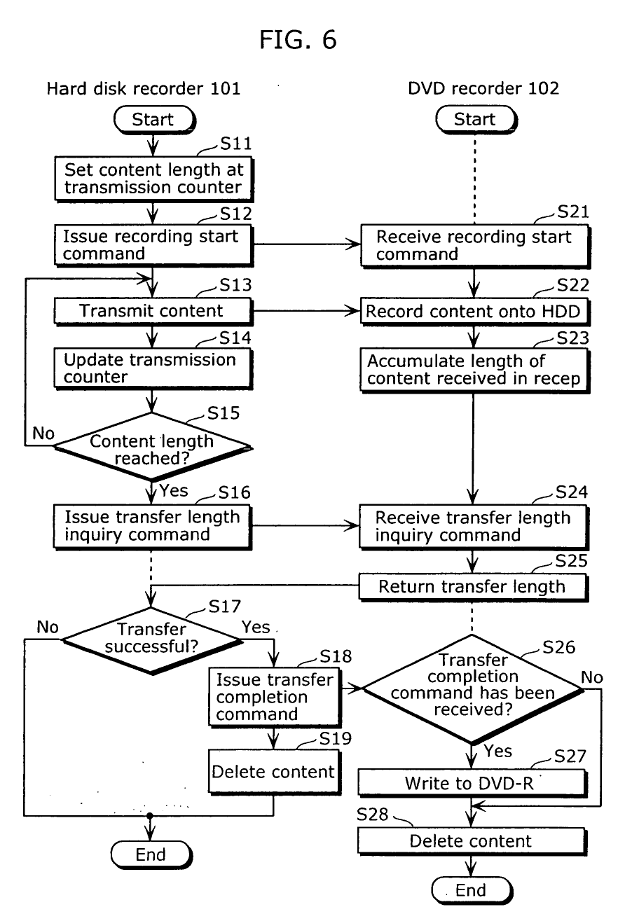

FIG. 6 is a flowchart illustrating a content moving procedure according to this embodiment of the present invention. A procedure for moving content recorded on the HDD 103 to the DVD-R 104 will now be described below. In the following description, it is assumed that a user has issued, to the controller 108 of the hard disk recorder 101, an instruction to move a file (i.e., the copy-once content) recorded on the HDD 103 within the hard disk recorder 101 to the DVD-R 104 within the DVD recorder 102.

First, the controller 108 of the hard disk recorder 101 acquires information (hereinafter referred to as a “content length”) of a length of the whole of user-specified content on the HDD 103 via the file reading unit 210, and sets the acquired content length at the transmission counter 202 (S11). Then, the controller 108 issues a recording start command 130 to the DVD recorder 102 (S12), and reads the user-specified content from the HDD 103 to transmit the read content to the DVD recorder 102 in a sequential manner (S13).

Upon receipt of the recording start command 130 via the network I/F 106 (S21), the controller 109 of the DVD recorder 102 instructs the recording circuit 105 to record the content to be received onto the HDD 210. In accordance with the instruction from the controller 109, the recording circuit 105 records the content received via the network I/F 106 onto the HDD 210 (S22), and provides to the controller 109 notification of the length of the content of which the recording has been completed. The controller 109 receives this notification and accumulates the length of the content of which the recording has been completed (i.e., the length of content as received) in the reception counter 221 (S23).

In accordance with a length of content as transmitted, the controller 108 of the hard disk recorder 101 updates the transmission counter 202 (S14). The transmission of the content is continued until a cumulative value of the length of the content as transmitted reaches the content length (S15). Specifically, since the content length is set in the transmission counter 202 (S11), the value of the transmission counter 202 is reduced in accordance with the length of the content as transmitted (S14). When the value of the transmission counter 202 has thus reached zero, the controller 108 of the hard disk recorder 101 determines that the transmission of the whole of the user-specified content has been completed. When the transmission of the whole of the content is completed, the controller 108 issues a transfer length inquiry command 132 to the DVD recorder 102 (S16).

Upon receipt of the transfer length inquiry command 132 via the network interface 106 (S24), the controller 109 of the DVD recorder 102 reads the value (i.e., the length of the content received) of the reception counter 221, and returns the read value to the hard disk recorder 101 as a transfer length 133 (S25).

Upon receipt of the transfer length 133 from the DVD recorder 102, the controller 108 of the hard disk recorder 101 compares the transfer length 133 with the cumulative value of the length of the content transmitted by the controller 108 itself (S17). When these two lengths coincide with each other, the controller 108 determines that the whole of the content transmitted by the controller 108 itself has been transferred to the DVD recorder 102 successfully. Meanwhile, when the two lengths do not coincide with each other or the transfer length 133 is not returned from the DVD recorder 102, the controller 108 determines that the content transmitted by the controller 108 itself has not been transferred to the DVD recorder 102 successfully.

When it is determined that the content has been transferred to the DVD recorder 102 successfully (Yes at S17), the controller 108 of the hard disk recorder 101 issues a transfer completion command 131 to the DVD recorder 102 (S18), and also issues the file deletion instruction 203 to the HDD 103 to delete from the HDD 103 the content the transmission of which has been completed (S19). Upon receipt of the transfer completion command 131 (Yes at S26), the controller 109 of the DVD recorder 102 issues the DVD-writing instruction 220 to the DVD-writing circuit 211. Upon receipt of the DVD-writing instruction 220, the DVD-writing circuit 211 writes the content recorded on the HDD 210 to the DVD-R 104 (S27), and, after completing this writing to the DVD-R 104, issues a writing completion notification 222 to the controller 109. Upon receipt of the writing completion notification 222, the controller 109 issues the file deletion instruction 212 to the HDD 210 to delete the content on the HDD 210 (S28).

Meanwhile, when it is determined that the content has not been transferred to the DVD recorder 102 successfully (No at S17), the controller 108 of the hard disk recorder 101 neither issues the transfer completion command 131 to the DVD recorder 102 nor deletes the content on the HDD 103. The timer 223 of the DVD recorder 102 is measuring a length of time that has passed since discontinuance of the reception of the content from the hard disk recorder 101, and outputting the measured length of time to the controller 109. When neither the transfer completion command 131 nor the content is sent from the hard disk recorder 101 for a predetermined time (e.g., ten seconds) after the latest reception of the content (No at S26), the controller 109 determines that a communication trouble has occurred in the course of the transfer of the content. When it is determined that the communication trouble has occurred in the course of the transfer, the controller 109 instructs the recording circuit 105 to stop the recording of the content, and issues the file deletion instruction 212 to the HDD 210. As a result, the content recorded on the HDD 210 is deleted without being written to the DVD-R 104 (S28).

As described above, according to this embodiment of the present invention, even when a network trouble occurs while the DVD recorder 102 is receiving the content from the hard disk recorder 101, the content in the hard disk recorder 101 remains recorded as it was before start of the transmission, and no fragment of the content, the transfer of which has ended in failure, is left on the DVD-R 104 on the DVD recorder 102. In other words, it is possible to prevent a single piece of content from being divided into two parts, with one part recorded in one device and the other part recorded in the other device, and to prevent a loss of a part of the content.

Note that, in the present embodiment, the HDD is applied as an exemplary primary storage medium in the content reception apparatus. However, the primary storage medium is not limited to the HDD. An erasable medium (e.g., a semiconductor memory) can also be adopted as the primary storage medium without affecting an effect of the present invention.

Also note that, in the present embodiment, the content transmission apparatus and the content reception apparatus are connected to each other via the network. However, the apparatus at the transmitting end and the apparatus at the receiving end can be connected to each other via a bus, such as an Institute of Electrical and Electronic Engineers (IEEE) 1394 bus or the like, without affecting the effect of the present invention.

Also note that, in the present embodiment, a method of checking the transfer length is adopted as a method for checking completion of the transfer between the content transmission apparatus and the content reception apparatus. However, the method for checking the completion of the transfer is not limited to this example. Any other checking methods may be adopted as long as it is possible to check successful completion of the transfer of a previously supposed amount of content (i.e., a predetermined unit amount of content) between the content transmission apparatus and the content reception apparatus. For example, in the case where isochronous communication on the IEEE 1394 bus is used for the content transfer, a transfer delay on the bus is extremely slight. In such an environment, it may be so arranged that the content transmission apparatus declares start of moving of the content by transmitting a move start command to the content reception apparatus before starting the transmission of the content, and transmits a move completion command to the content reception apparatus when the transmission of the supposed amount of content has been completed. In this case, the content reception apparatus receives the move completion command and then returns a response indicative of successful completion, so that the content transmission apparatus can recognize the completion of the transfer by receiving this response.

Note that not only in the case where a trouble has occurred on the network 100 but also in the case where a trouble has occurred on a bus within the DVD recorder 102, the problem of unsuccessful completion of content movement will result. In general, however, a frequency with which the trouble occurs on the bus within the DVD recorder 102 is negligibly low compared to a frequency with which the trouble occurs on the network 100.

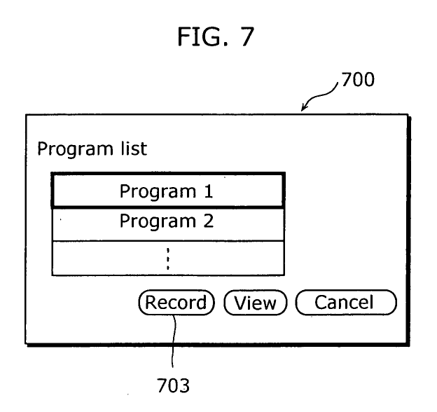

Also note that, in the present embodiment, the completion of the transfer is checked on a file-by-file basis. However, the completion of the transfer may be checked on a program-by-program basis. For example, referring to FIG. 7, when a record button 703 is pressed when program 1 is being selected in a program list 700, this operation is notified to the controller 108. In this case, in the case where program 1 is recorded on the HDD 103 as a single file, the completion of the transfer is checked on a file-by-file basis. Meanwhile, in the case where program 1 and program 2 are recorded as a single file on the HDD 103, the completion of the transfer is checked on a program-by-program basis.

Although not mentioned in the foregoing description, the content transmitted from the hard disk recorder 101 has generally been encrypted using an encryption system specified in the DTCP standard. As such, in the case where the content transmitted from the hard disk recorder 101 is encrypted, the decryption unit 232 of the DVD recorder 102 decrypts the encrypted content. The encryption unit 233 of the DVD recorder 102 encrypts the content decrypted by the decryption unit 232 again, using another encryption system. This makes it possible to write the content as encrypted again by the encryption unit 233 to the DVD-R 104, resulting in improved security.

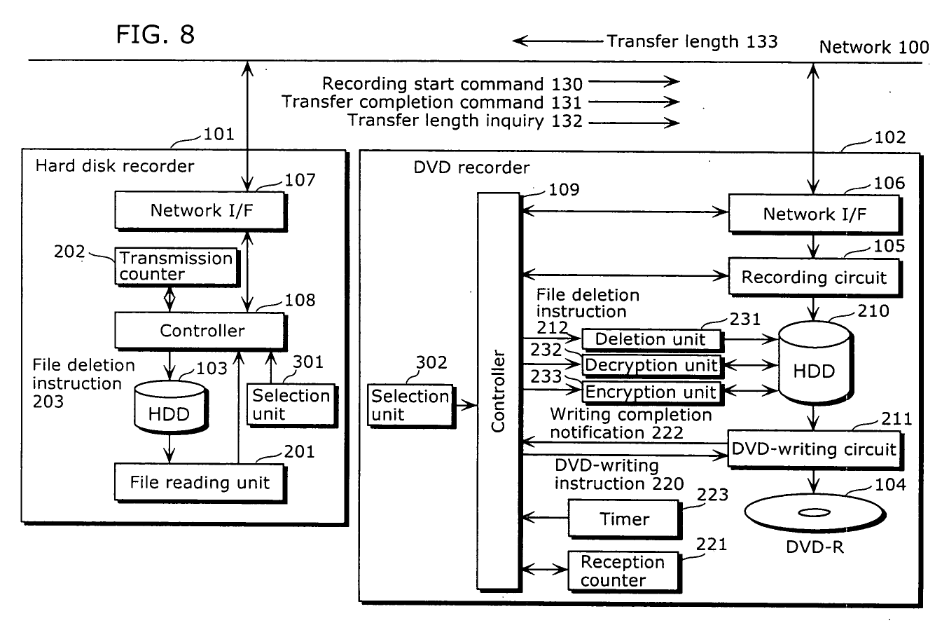

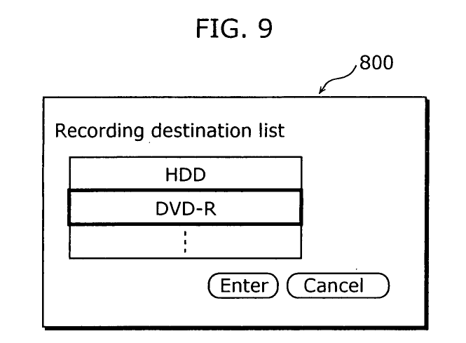

Note that, referring to FIG. 8, the DVD recorder 102 may be provided with a selection unit 302 for selecting either the HDD 210 or the DVD-R 104 as a recording destination of the received content. That is, when accepting specification of the content from the user, the selection unit 302 accepts specification of a recording destination of the content as well. Although no particular limitation is imposed on a method for specifying the recording destination, it is preferable to adopt a method in which a content recording destination list 800 is presented to the user so that the user selects one item in the list 800, as shown in FIG. 9. In the case where the HDD 210 is selected as the recording destination of the content, the content on the HDD 210 is neither deleted nor written to the DVD-R 104 even after the completion of the transfer is verified by the content transmission apparatus and the content reception apparatus. Thus, easier selection of the recording destination of the content is made possible, resulting in improved user convenience.

Such a selection unit may be provided in a device that accepts a user specification. That is, a selection unit 301 within the hard disk recorder 101 may be used instead of the selection unit 302 within the DVD recorder 102. In this case, information of the recording destination accepted by the selection unit 301 within the hard disk recorder 101 is embedded in a command that is transmitted from the hard disk recorder 101 to the DVD recorder 102, for example. In this case, since the controller 109 of the DVD recorder 102 is able to receive the command and extract from the command the information of the recording destination of the content, a similar effect to that achieved when the DVD recorder 102 is provided with the selection unit 302 is achieved.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable, for example, to a DVD recorder that has a need to prevent an inconvenience from occurring even when, in the case where content received from another device is to be recorded onto a write-once medium, a network trouble occurs in the course of receiving the content.

What is claimed is:

1. A content reception apparatus that receives a content, said content reception apparatus comprising:
a primary storage medium which is a storage medium that allows multiple rewriting;
a secondary storage medium which is a write-once storage medium;
a reception unit operable to receive the content;
a recording unit operable to record the content received by said reception unit onto said primary storage medium;
a first check unit operable to check, in conjunction with a content transmission apparatus, that said reception unit has completed reception of a whole of the content to be received; and
a moving unit operable to move the content recorded on said primary storage medium to said secondary storage medium, when the whole of the content to be received has been recorded on said primary storage medium,
wherein, when a content which cannot be duplicated and which is recorded on a storage medium in the content transmission apparatus is to be moved to said secondary storage medium, said moving unit is operable to move the content recorded on said primary storage medium to said secondary storage medium after the check by said first check unit is completed.

2. The content reception apparatus according to claim 1, further comprising
a deletion unit operable to delete or make unusable the content recorded on said primary storage medium, when the whole of the content to be received has not been recorded on said primary storage medium successfully.

3. The content reception apparatus according to claim 2, further comprising
a second check unit operable to check, in conjunction with the content transmission apparatus and by using a command, a failure in completion of transfer of a predetermined unit amount,
wherein said deletion unit is operable to delete or make unusable the content recorded on said primary storage medium, when the failure in the completion of the transfer of the predetermined unit amount is verified by said second check unit.

4. The content reception apparatus according to claim 1,
wherein said first check unit is operable to determine that transfer of a predetermined unit amount has been completed successfully, when a length of the content recorded on said primary storage medium has reached a length of the content to be received.

5. The content reception apparatus according to claim 3,
wherein said second check unit is operable to determine that the transfer of the predetermined unit amount has not been completed successfully, when neither the content nor the command has been received from the content transmission apparatus for a predetermined time.

6. The content reception apparatus according to claim 1,
wherein said first check unit is operable to check completion of transfer on a file-by-file basis or on a program-by-program basis, and
said moving unit is operable to move the content recorded on said primary storage medium to said secondary storage medium on a file-by-file basis or on a program-by-program basis.

7. The content reception apparatus according to claim 3,
wherein said second check unit is operable to check the failure in the completion of the transfer, on a file-by-file basis or on a program-by-program basis, and
said deletion unit is operable to delete or make unusable the content recorded on said primary storage medium, on a file-by-file basis or on a program-by-program basis.

8. The content reception apparatus according to claim 1, further comprising:
a decryption unit operable to, when the content received is encrypted, decrypt the encrypted content; and
an encryption unit operable to encrypt again the content decrypted by said decryption unit,
wherein said moving unit is operable to move the content encrypted again by said encryption unit to said secondary storage medium.

9. The content reception apparatus according to claim 8,
wherein said decryption unit is operable to decrypt a content which is encrypted using an encryption system specified in the Digital Transmission Content Protection (DTCP) standard.

10. The content reception apparatus according to claim 1, further comprising
a selection unit operable to select either said primary storage medium or said secondary storage medium as a recording destination of the received content,
wherein said moving unit is operable to move the content recorded on said primary storage medium to said secondary storage medium, only when said secondary storage medium is selected by said selection unit.

11. A content reception method for receiving a content, said method comprising:
receiving the content;
recording the received content onto a primary storage medium which is a storage medium that allows multiple rewriting;
checking, in conjunction with a content transmission apparatus, that reception of a whole of the content to be received has been completed; and
moving the content recorded on the primary storage medium to a secondary storage medium which is a write-once storage medium, when the whole of the content to be received has been recorded on the primary storage medium,
wherein in said moving, when a content which cannot be duplicated and which is recorded on a storage medium in the content transmission apparatus is to be moved to the secondary storage medium, the content recorded on the primary storage medium is moved to the secondary storage medium after the check in said checking is completed.

12. A program for receiving a content, said program causing a computer to execute:
receiving the content;
recording the received content onto a primary storage medium which is a storage medium that allows multiple rewriting;
checking, in conjunction with a content transmission apparatus, that reception of a whole of the content to be received has been completed; and
moving the content recorded on the primary storage medium to a secondary storage medium which is a write-once storage medium, when the whole of the content to be received has been recorded on the primary storage medium,
wherein in said moving, when a content which cannot be duplicated and which is recorded on a storage medium in the content transmission apparatus is to be moved to the secondary storage medium, the content recorded on the primary storage medium is moved to the secondary storage medium after the check in said checking is completed.

13. A content transmission apparatus that transmits a content, said apparatus comprising:
a storage medium having on which a content which cannot be duplicated is recorded;
a transmission unit operable to transmit the content;
a first check unit operable to check, in conjunction with a content reception apparatus, that said transmission unit has completed transmission of a whole of the content to be transmitted; and
a deletion unit operable to delete the content recorded on said storage medium after the check by said first check unit is completed.

14. A content moving system for moving content from a content transmission apparatus that transmits the content to a content reception apparatus that receives the content,
wherein said content transmission apparatus includes:
a storage medium on which a content which cannot be duplicated is recorded;
a transmission unit operable to transmit the content;
a first check unit operable to check, in conjunction with said content reception apparatus, that said transmission unit has completed transmission of a whole of the content to be transmitted; and
a deletion unit operable to delete the content recorded on said storage medium after the check by said first check unit is completed, and
wherein said content reception apparatus includes:
a primary storage medium which is a storage medium that allows multiple rewriting;
a secondary storage medium which is a write-once storage medium;
a reception unit operable to receive the content;
a recording unit operable to record the content received by said reception unit onto said primary storage medium;
a first check unit operable to check, in conjunction with said content transmission apparatus, that said reception unit has completed reception of a whole of the content to be received; and
a moving unit operable to move the content recorded on said primary storage medium to said secondary storage medium, when the whole of the content to be received has been recorded on said primary storage medium,
wherein, when the content which cannot be duplicated and which is recorded on said storage medium in said content transmission apparatus is to be moved to said secondary storage medium, said moving unit is operable to move the content recorded on said primary storage medium to said secondary storage medium after the check by said first check unit is completed.
